(19) United States
(12) Patent Application Publication
(10) Pub. No.: US 2008/0282857 A1
(43) Pub. Date: Nov. 20, 2008

(54) Cutting machine for use in removing damaged oilfield rigs and equipment located in offshore waters, and method of using same

(76) Inventors: John J. Khoury, Houston, TX (US); Leon Ortemond, Franklin, LA (US)

Correspondence Address: THE MATTHEWS FIRM, 2000 BERING DRIVE, SUITE 700, HOUSTON, TX, 77057, US

(21) Appl. No.: 11/804,305

(22) Filed: May 16, 2007

(51) Int. Cl. B26D 3/00; B26D 1/00

(52) U.S. Cl. 83/54; 83/694

(57) ABSTRACT

An apparatus for cutting off metal piles, casing, conductor pipe and other metal tubulars, uses a metal frame and a metal blade linearly moveable within the frame, the blade being hydraulically and/or pneumatically driven to puncture and then slice and split through the metal being cut off, the cutting surface of the blade having a removable, centralized puncture point located essentially at the projected intersection between two concave cutting surfaces.

### BACKGROUND OF THE INVENTION

This invention relates, generally, to a new and improved machine for cutting metal structures, typically made from steel, which have been partially destroyed during offshore storms which often times prevent the structures from being moved to another location. These structures take a variety of forms, but can include drill ships, drilling platforms, steel casing and risers, but will also include various other forms, including metal piles used to anchor and support offshore platforms, and the associated well casing and conductor pipe arrangements.

Several mechanical cutting devices have been developed over the past 25-30 years that employ the use of hydraulic rams to cause a cutting blade to sever trees and concrete piles.

For example, U.S. Pat. No. 5,139,006 to Tradeau illustrates a machine for cutting concrete piles.

U.S. Pat. No. 5,245,982 to Tradeau illustrates yet another machine for cutting concrete piles.

U.S. Pat. No. 5,413,086 to Tradeau discloses another machine for cutting a concrete pile.

U.S. Publication No. 2005/0194000A1 to James J. Todack discloses another machine for shearing concrete and metal piles.

U.S. Pat. No. 4,261,388 to James B. Hawkins, et al, discloses a machine for cutting piling, trees or the like, and allows the machine to be opened up and placed around the tree or piling, as opposed to lowering the machine over the piling or cutting.

### BRIEF DESCRIPTION OF DRAWINGS

FIG. 1A is an isometric, top view of the cutting machine according to the invention;

FIG. 1B is an isometric, bottom view of the cutting machine illustrated in FIG. 1A;

FIG. 2A is a schematic, elevated view of the cutting blade according to the invention;

FIG. 2B is a schematic, elevated view of the cutting blade according to the invention having traveled further through the tubular than is illustrated in FIG. 2A;

FIG. 3A is a partial, top plan view of a pair of cutting blades according to the invention, prior to being cut into two separate blades;

FIG. 3B is a front view of the pair of blades illustrated in FIG. 3A;

FIG. 3C is a side view of one of the puncture points illustrated in FIGS. 3A and 3B;

FIG. 4A is a partial top plan view of an alternative embodiment of a cutter blade having a puncture point according to the invention;

FIG. 4B is a front view of the cutter blade according to FIG. 4A;

FIG. 4C is a side view of the puncture point illustrated in FIG. 4A;

FIG. 5A is an elevated view of a cross-member used in the frame of the cutting machine according to FIG. 1A;

FIG. 5B is an elevated view of a second cross-member used in the frame of the cutting machine according to FIG. 1A;

FIG. 6 is an exploded view of the gate assembly used in the cutting machine illustrated in FIG. 1A;

FIG. 7 is an isometric view of the gate assembly, illustrated in FIG. 6, following the assembly of the gate;

FIG. 8A is an isometric view of the latch assembly used in accordance to the present invention to keep the gate closed while the metal tubular is being cut; and

FIG. 8B is a top plan view of the latch assembly illustrated in FIG. 8A.

### DETAILED DESCRIPTION OF PREFERRED EMBODIMENTS OF INVENTION

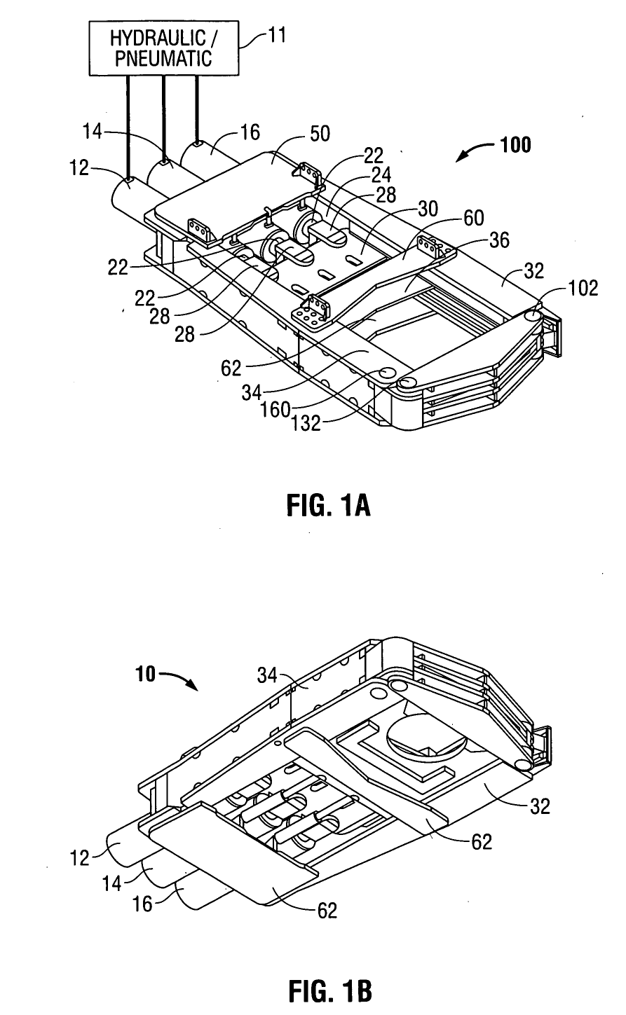

Referring now to FIGS. 1 and 1B of the drawings, there is illustrated two (2) isometric views, FIG. 1A as viewed from the top and FIG. 1B as viewed from the bottom, of the cutting machine 10 according to the invention. The machine 10 includes three (3) hydraulic cylinders 12, 14 and 16 having pistons 18, 20 and 22, respectively, which can operate withhydraulic and/or pneumatic pressure from the conventional source 11.

The cutting blade 30, described in greater detail hereinafter, is connected to pistons 18, 20 and 22 by the arms 24, 26 and 28, respectively.

In operation, the cutting blade 30 moves back and forth within the frame formed, in part, by frame members 32 and 34, as the pistons 18, 20 and 22 reciprocate within the cylinders 12, 14 and 16.

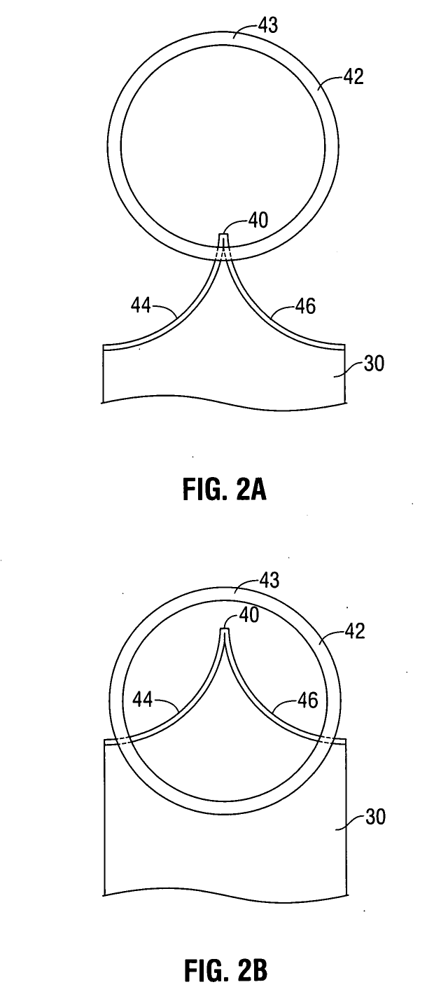

It should be appreciated that the cutting edge 36 of the cutter is preferably not straight edged, as illustrated in FIG. 1A but preferably is as illustrated in FIGS. 2A and 2B.

Referring now to FIGS. 2A and 2B, there is illustrated a schematic version of the preferred embodiments of the cutting blade 30. The cutting surface of the blade 30 has a pointed end 40 which punctures a steel casing 42 in FIG. 2A. The cutting surface also includes a pair of concave surfaces 44 and 46, which together lead up to the puncture point 40. Thus, the puncture point 30 is located at the projected point of intersection of the concave surfaces 44 and 46. The radius of curvature for the surfaces 44 and 46 can be the same, or slightly different, if desired, but preferably are in the range of about 10″ to about 25″, and even more preferably have a radius of curvature either between about 11.85″ and 11.91″, or between about 23.7″ to 23.82″. However, the invention contemplates either or both of the concave surfaces 44 and 46 can have a radius of curvature of less than 10″ or greater than 25″.

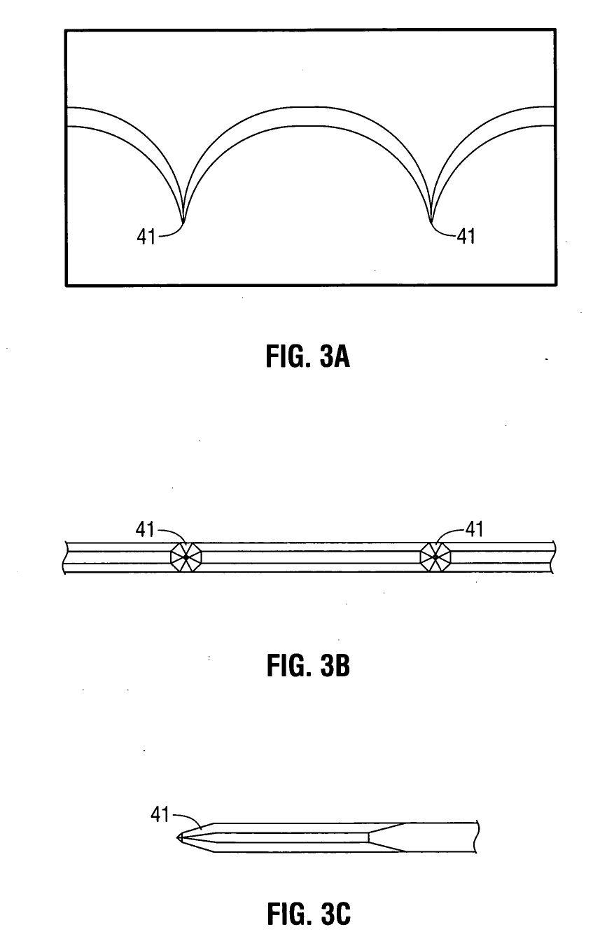

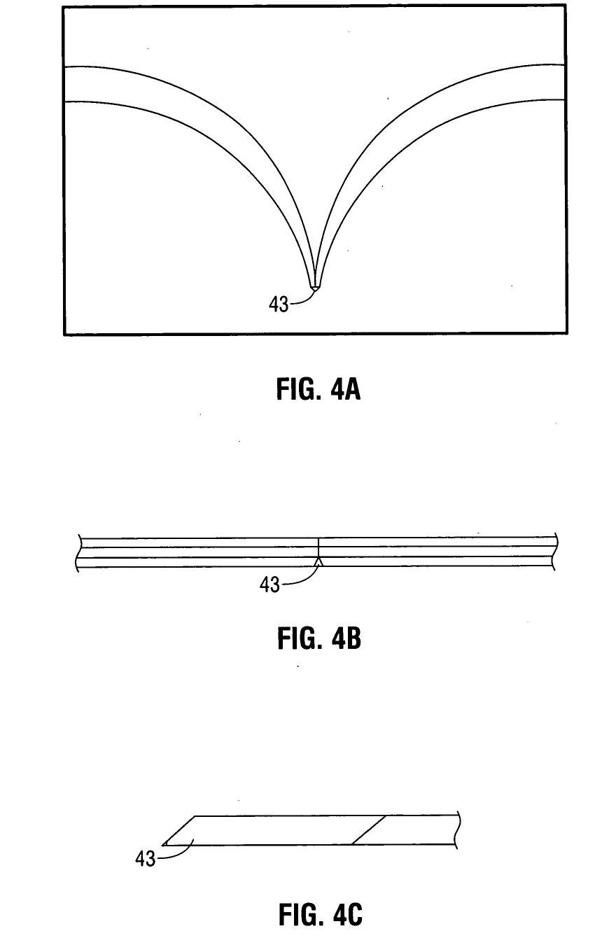

The puncture point 40 preferably has a removable tip 41, which is easily replaceable, such as illustrated in FIGS. 3A, 3B and 3C, or the removable tip 43, which is easily replaceable, in FIGS. 4A, 4B and 4C.

The removable tip allows the cutter 30 to be used further in the event the tip is damaged when puncturing hard metal such as the steel casing 42 in FIGS. 2A and 2B.

In operation, because of the angle created along the sides of the puncture point 40, as illustrated in FIG. 2A, due to the concave cutting surfaces 44 and 46, the surfaces tend to slice through the metal casing 42 instead of mashing the metal casing. As the cutter 30 moves through the casing, as shown in FIG. 2B, the angle of the cutting surfaces continues to slice and then split through the casing 42. Although not illustrated, the further movements of the cutter 30 will cause the tip 40 to again puncture the casing 42 at location 43 on the casing, roughly 180° from the initial punction illustrated in FIG. 2A and for the surfaces 44 and 46 to completely cut through the casing 42.

Referring further to FIGS. 1A and 1B, the frame of the cutting machine 10 having the members 32 and 34, also has a top plate 50 (FIG. 1A) and a lower plate 52 (FIG. 1B) which are each mounted to each of the frame members 32 and 34 to provide mechanical stability to the frame. The frame members 32 and 34 are preferable parallel to each other. The plates 50 and 52 are also preferably parallel to each other. The plates 50 and 52 are mounted to the members 32 and 34 by any conventional fasteners, but preferably by welding. The frame members 32 and 34, as well as the plates 50 and 52 are preferably manufactured from hard metal such as, for example, case-hardened steel. For use in offshore environments, usually salt water, the entire cutting machine 10 is preferably coated, painted or otherwise treated to be rust resistant to the salt water. The invention contemplates that when the cutting machine 10 is used to cut metal piles, metal casing or the like, underneath the surface of the water, the machine 10, as well as the source 11 for the hydraulic and/or pneumatic pressure can be mounted on an underwater skid which can be moved along underneath the surface of the water by one (1) or more divers in a manner well known in the diving industry.

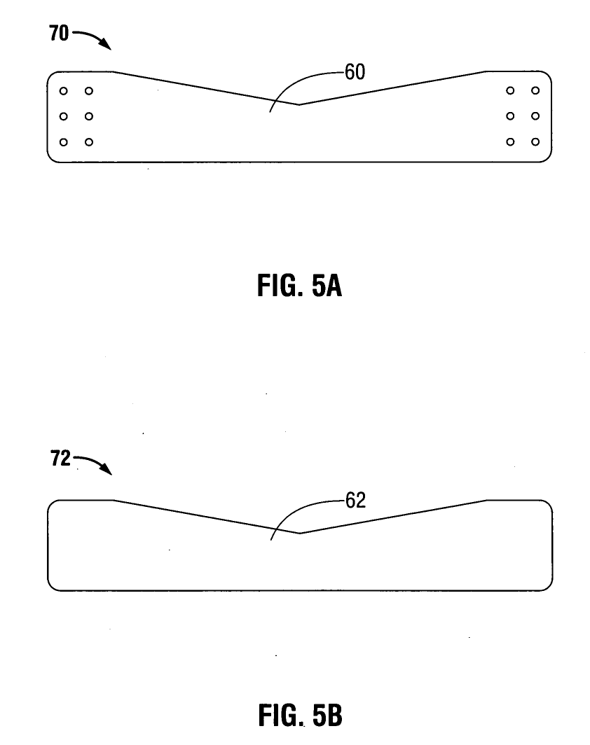

Also in FIGS. 1A and 1B, the machine 10 has a pair of plates 60 and 62, each of which is mounted to the frame members 32 and 34, and each of which has a V-shaped front surface 70 and 72, respectively, for engaging the casing 42 or other metal to be cut. The plates 60 and 62 are shown in greater detail in FIGS. 5A and 5B, respectively. The plates 60 and 62 are mounted by conventional fasteners, such as bolts, or by welding to the frame members 32 and 34. If bolted, the plates 60 and 62 can be moved back and forth to provide a better connection to the tubular being cut. The plates 60 and 62 provide additional stability to the frame including members 32 and 34, as well as plates 50 and 52.

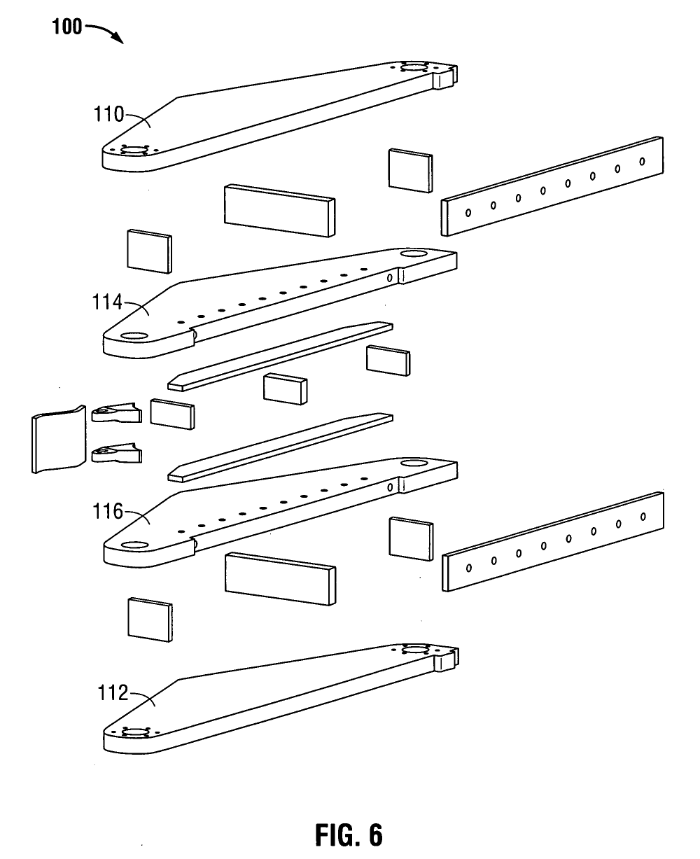

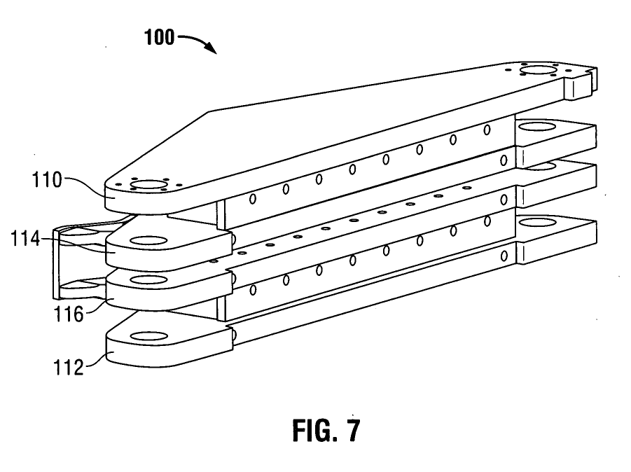

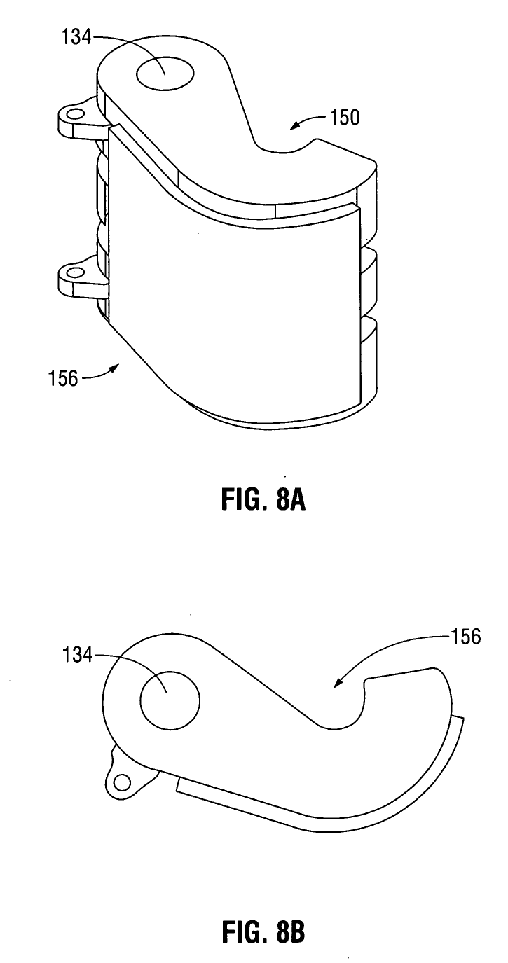

Also in FIGS. 1A and 1B, there is illustrated a gate assembly 100 which is pivotable around a hinge pin 102. FIG. 6 illustrates in an exploded view, the principal parts of the gate assembly 100, and includes an upper plate 110, a lower plate 112, and a pair of intermediate plates 114 and 116. Spacers (unnumbered) are illustrated for maintaining separation between the plates. FIG. 7 illustrates the gate assembly 100 after the plates and spacers of FIG. 6 have been assembled together. FIGS. 8A and 8B illustrate a rotatable latch assembly 130 which rotates around a hinge pin 132 illustrated in FIG. 1A. The plates 110, 112, 114 and 116 each has one pivot hole for the hinge pin 102 and one pivot hole for the hinge pin 132. The latch assembly 130 has a pivot hole 134 for receiving the hinge pin 132.

In the operation of the gate assembly 100 and the latch assembly 130, hydraulic and/or pneumatic power, for example, from the source 11, is used to pivot the gate assembly 100 to the open position by causing the gate assembly 100 to pivot about the hinge pin 102. After the gate assembly is open, the cutting machine 10 is moved to envelop the part to be cut, for example, the steel casing 42 of FIGS. 2A and 2B. As soon as the casing 42 is touched by the V-shaped plates 60 and 62, hydraulic and/or pneumatic power is used to close the gate assembly 100 and then the rotation of the latch assembly 130 to thereby secure the casing 42 within the cutting machine 10. The latch assembly 130 has a J-shaped profile 150 to latch onto a hinge pin 160 running through the frame member 34, or alternatively, to any other latch pin or mechanism secured to the frame, to secure the gate assembly 130 in the closed position.

The cylinders 12, 14 and 16 are then activated by hydraulic and/or pneumatic power, to move the cutting blade to a position to puncture the casing 42 and then to slice and split the casing 42 all the way through. The cutter 30 can partially enter the gate assembly between the plates 114 and 116, or, as an option, be stopped just short of the gate assembly, as desired, by using different sized inserts, depending upon the size of the pile or the casing, or the like being cut, to proved an anvil surface against which the pile or casing resides to enable the cut to go completely through the pile or casing.

1. An apparatus for cutting metal piles, casing and other tubulars, comprising:
a metal frame having first and second ends;
at least one cylinder and piston assembly mounted at said first end of said frame responsive to hydraulic and/or pneumatic pressure;
a metal blade linearly moveable within said frame responsive to the application of hydraulic
and/or pneumatic pressure to said at least one cylinder, the cutting surfaces of said blade comprising first and second concave surfaces, and a puncture point located at or near the projected intersection of the first and second concave surfaces.

2. The apparatus according to claim 1, comprising in addition thereto, a gate assembly pivotably mounted to said second end of said frame, whereby the opening of said gate assembly allows the frame to be moved to envelope the metal pile, casing or other tubular to be cut.

3. The apparatus according to claim 1, wherein said puncture point is removable and replaceable on said metal blade.

4. The apparatus according to claim 1, wherein said first and second concave surfaces each has a substantially constant radius of curvature.

5. The apparatus according to claim 4, wherein said substantially constant radius of curvature is in the range of about 10′″ to about 25″.

6. The apparatus according to claim 5, wherein said radius of curvature is in the range of about 11.85″ to about 11.91″.

7. The apparatus according to claim 5, wherein said radius of curvature is in the range of 23.7″ to 23.82″.

8. A metal cutting blade for cutting metal piles, casing and other tubulars, said blade have cutting surfaces comprising first and second concave surfaces, and a puncture point located at or near the projected intersection of the first and second concave surfaces.

9. The blade according to claim 8, wherein said puncture point is removable and replaceable on said metal blade.

10. The blade according to claim 8, wherein said first and second concave surfaces each has a substantially constant radius of curvature.

11. The blade according to claim 10, wherein said substantially constant radius of curvature is in the range of about 10″ to about 25″.

12. The apparatus according to claim 11, wherein said radius of curvature is in the range of about 11.85″ to about 11.91″.

13. The apparatus according to claim 11, wherein said radius of curvature is in the range of about 23.7″ to about 23.82″.

14. A method for cutting metal piles, casing and other tubulars, comprising the steps of:
transporting a metal frame to the proximity of the metal pile, casing or other tubular to be cut;
opening a gate at one end of said frame;
moving the frame to envelop said metal pile, casing or other tubular after said gate is open;
closing the gate of said frame;
driving a metal blade in said frame through said metal pile, casing or other tubular, said blade having cutting surfaces comprising first and second concave surfaces, and a puncture point located at or near the projected intersection of the first and second concave surfaces.

15. The method of claim 14, wherein the driving of the metal blade through the metal pile, casing or other tubular is accomplished by hydraulic and/or pneumatic pressure.

16. The method of claim 14, wherein the driving of the metal blade through the metal pile, casing or other tubular is accomplished, at least in part, under the surface of a body of water.
